(19) United States
(12) Patent Application Publication
(10) Pub. No.: US 2014/0110466 A1
(43) Pub. Date: Apr. 24, 2014

(54) CONTAINER WITH INTEGRATED LID

(71) Applicant: GAMIDEA, LLC, Poughkeepsie, NY (US)

(72) Inventor: Timothy D. Huang, Rochester Hills, MI (US)

(73) Assignee: GAMIDEA, LLC, Poughkeepsie, NY (US)

(21) Appl. No.: 13/654,442

(22) Filed: Oct. 18, 2012

(51) Int. Cl. A47G 19/22; B31B 1/25; B65D 43/16

(52) U.S. Cl. 229/404; 229/128; 493/152

(57) ABSTRACT

Aspects of the invention are directed to a container comprising a bottom and a sidewall. The sidewall is coupled to the bottom so as to form a watertight seal therewith. In addition, the sidewall defines a lower sidewall portion and an upper sidewall portion. The upper sidewall portion is scored with a plurality of lines. These lines are arranged such that folding the upper sidewall portion along at least a portion of the plurality of lines converts the upper sidewall portion into a lid for the container.

### FIELD OF THE INVENTION

The present invention relates generally to containers, and, more particularly, to containers such as drink cups with integrated lids.

### BACKGROUND OF THE INVENTION

Paper cups are widely used throughout the world as disposable, one-use cups. Typical paper cups are formed of paper coated with a water-impermeable barrier such as a plastic (e.g., polyethylene, polylactic acid) or a wax. To form a paper cup, flat paper is cut into an appropriate shape and rolled and welded to form a hollow sleeve. A bottom is then attached to the bottom of the hollow sleeve. Finally, an upper portion of the hollow sleeve is rolled back onto itself to form a protruding rim.

Paper cups are frequently utilized with separate, snap-on lids. In contrast to the paper cups, the lids are typically formed of a plastic (e.g., polystyrene, polyvinylchloride, polyethylene terephthalate) utilizing a mold with a thermoforming process. Unfortunately, although ubiquitous, the use of such lids has several disadvantages. Disposable cups and their lids require, for example, entirely separate material sourcing, manufacturing, and distribution processes. In addition, differences in materials between the cups and the lids require that they be separated from each other before recycling, making such recycling more difficult. Forming the protruding rims on the cups needed for the separate lids also requires that the cups contain more paper. Lastly, a user of disposable cups and lids must separately acquire two separate items.

For the foregoing reasons, there is a need for disposable cup designs that can benefit from the advantages of having lids while addressing the above-identified disadvantages.

### SUMMARY OF THE INVENTION

Embodiments of the present invention address the above-identified needs by providing container designs with integrated lids that address the above-identified deficiencies.

Aspects of the invention are directed to a container comprising a bottom and a sidewall. The sidewall is coupled to the bottom so as to form a watertight seal therewith. In addition, the sidewall defines a lower sidewall portion and an upper sidewall portion. The upper sidewall portion is scored with a plurality of lines. These lines are arranged such that folding the upper sidewall portion along at least a portion of the plurality of lines converts the upper sidewall portion into a lid for the container.

### BRIEF DESCRIPTION OF THE DRAWINGS

These and other features, aspects, and advantages of the present invention will become better understood with regard to the following description, appended claims, and accompanying drawings where:

FIG. 1 shows a side elevational view of a drink cup in accordance with a first illustrative embodiment of the invention;

FIGS. 2A-2E show side perspective views of the FIG. 1 drink cup before, during, and after folding to form a lid;

FIG. 3 shows a flow diagram of a method in accordance with an illustrative embodiment of the invention for forming the FIG. 1 drink cup;

FIG. 4 shows a side elevational view of a flat sidewall for the FIG. 1 drink cup;

FIG. 5 shows a side sectional view of a lower portion of the FIG. 1 drink cup;

FIGS. 6A-6E show side perspective views of a drink cup in accordance with a second illustrative embodiment of the invention before, during, and after folding to form a lid;

FIG. 7 shows a side elevational view of a flat sidewall for the FIG. 6 drink cup;

FIG. 8 shows a side elevational view of a flat sidewall for a drink cup in accordance with a third illustrative embodiment of the invention;

FIG. 9 shows a side elevational view of a flat sidewall for a drink cup in accordance with a fourth illustrative embodiment of the invention; and

FIG. 10 shows a perspective view of a drink cup in accordance with aspects of the invention and a conventional drink cup.

### DETAILED DESCRIPTION OF THE INVENTION

The present invention will be described with reference to illustrative embodiments. For this reason, numerous modifications can be made to these embodiments and the results will still come within the scope of the invention. No limitations with respect to the specific embodiments described herein are intended or should be inferred.

As used herein, the terms “score,” “scored,” and “scoring” are to be construed broadly and are intended to encompass any means of reducing a material's stiffness along a line to aid in subsequent folding along that line. For this reason, a process described herein as “scoring” a given material would include, but not be limited to, a process that compresses the material, a process that superficially cuts the material, a process that creases the material, a process that pre-bends the material, and a process that perforates the material, all in preparation for later folding.

FIG. 1 shows a side elevational view of a drink cup 100 in accordance with a first illustrative embodiment of the invention. For ease of description, the drink cup 100 can be conceptually separated into two parts: a bottom 105 and a sidewall 110. While the sidewall 110 comprises one unified element, it can also be further conceptually separated into a lower sidewall portion 115 and an upper sidewall portion 120.

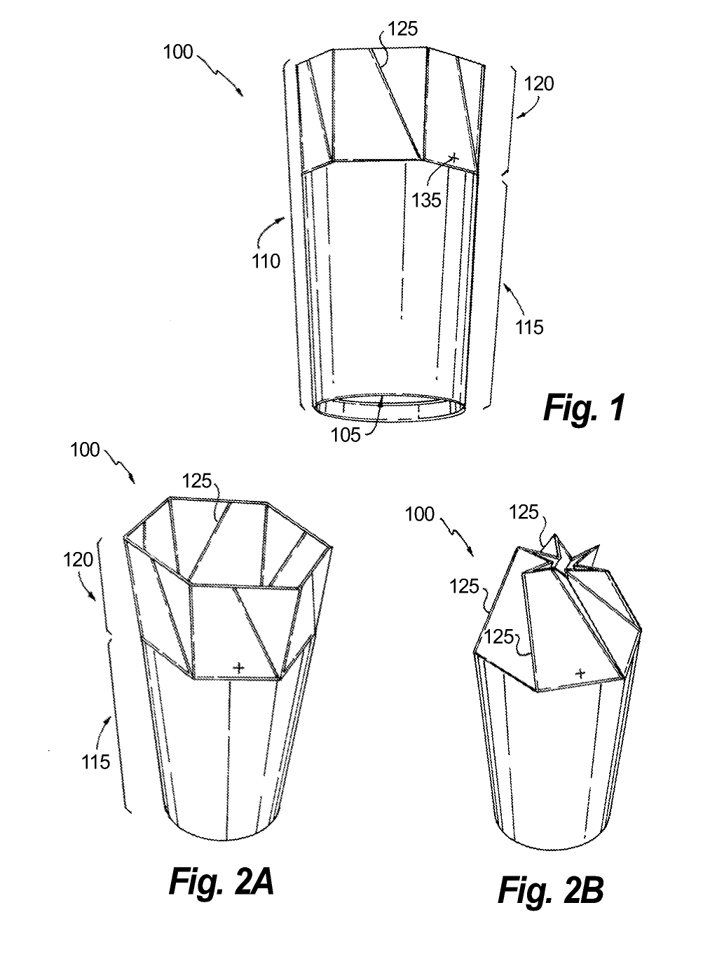

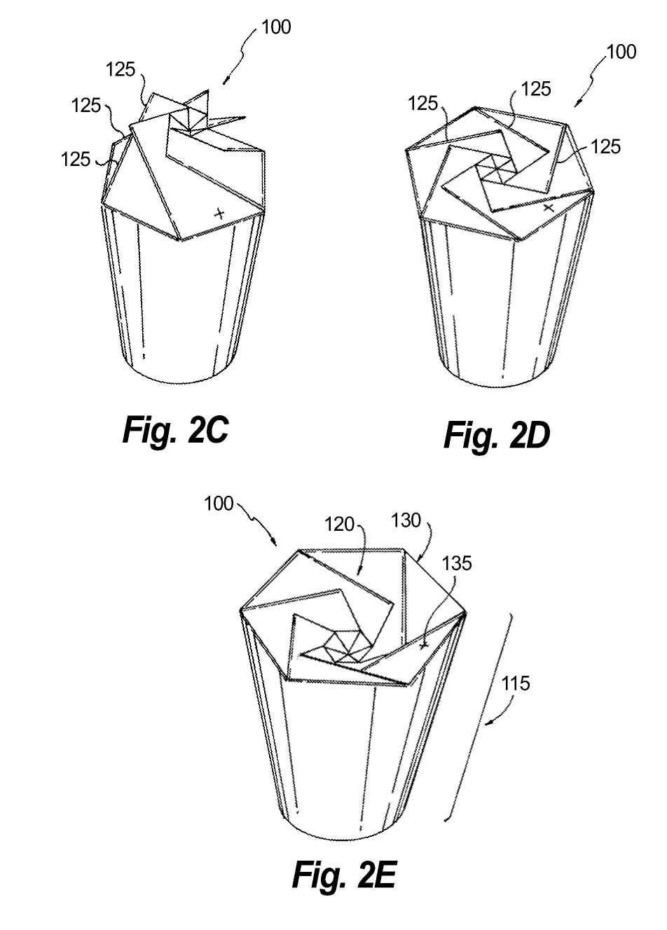

The drink cup 100 is designed so that the lid for the drink cup 100 is formed from a portion of the drink cup 100 itself rather than requiring the use of a separate plastic lid. More particularly, reference again to FIG. 1 shows that the upper sidewall portion 120 of the drink cup 100 is scored with a plurality of lines 125. These lines 125, in turn, are uniquely arranged such that folding the upper sidewall portion 120 along the lines 125 acts to convert the upper sidewall portion 120 into a lid 120 for the drink cup 100. FIGS. 2A-2E show side perspective views of the drink cup 100 before, during, and after such a folding process. As would be expected, the drink cup 100 in FIG. 2A appears substantially like it does in FIG. 1. In FIG. 2E, in contrast, the upper sidewall portion 120 has been fully converted into the lid 120 for the drink cup 100. In this particular illustrative embodiment, the lid 120 does not define any significant holes and thereby fills substantially the entire opening in the drink cup 100, while an upper rim 130 of the lower sidewall portion 115 (now the upper rim 130 of the drink cup 100) takes on a hexagonal shape. For convenience, a weakened region 135 in the lid 120, here formed in the shape of an “X,” accommodates the later insertion of a drinking straw.

The lid 120 (previously the upper sidewall portion 120) in FIG. 2E has a noticeable concave shape when viewed from above. Stated another way, a center point of the lid 120 in FIG. 2E is located between the bottom 105 and a plane defined by the upper rim 130 of the lower sidewall portion 115. This concave shape forms part of a unique “locking mechanism” that tends to keep the lid 120, once folded and properly positioned, from spontaneously loosening and unfolding. In the present embodiment, such a locking mechanism is provided by having the lid 120 be somewhat larger than what would be required to form a planar lid for the drink cup 100. This oversizing, in turn, acts to place the lid 120 under a high amount of compressive stress when the lid 120 is, at least transiently, placed into the “planar” state shown in FIG. 2D. Once achieving the “concave” state shown in FIG. 2E, in contrast, the lid 120 is under much less compressive stress due to the curvature in the lid 120 and its ability to occupy additional space. The planar state of the lid 120 shown in FIG. 2D thereby forms a potential barrier for the lid 120 once the lid 120 achieves its concave state shown in FIG. 2E. Accordingly, in practice, a user causes the lid 120 to enter its locked state by manually pressing the lid 120 past the high-stress, transient planar state and into the lower-stress, concave locked state. Such a transition provides the user with the sensation of the lid 120 “popping” or “snapping” into place. Once so positioned, the lid 120 has a tendency to stay as placed indefinitely because it has, without additional manual intervention by the user, no ability to overcome the potential barrier provided by the planar state. In fact, in this locked condition, the only way to subsequently unfold the lid 120 is to have the user intentionally and somewhat forcefully lift up on one or more of its six folds.

Prototype drink cups similar to the drink cup 100 were formed to test the functionality of this embodiment of the invention. These prototype drink cups were substantially leak free with their folded lids locked in place, even when full of liquid and turned on their respective sides.

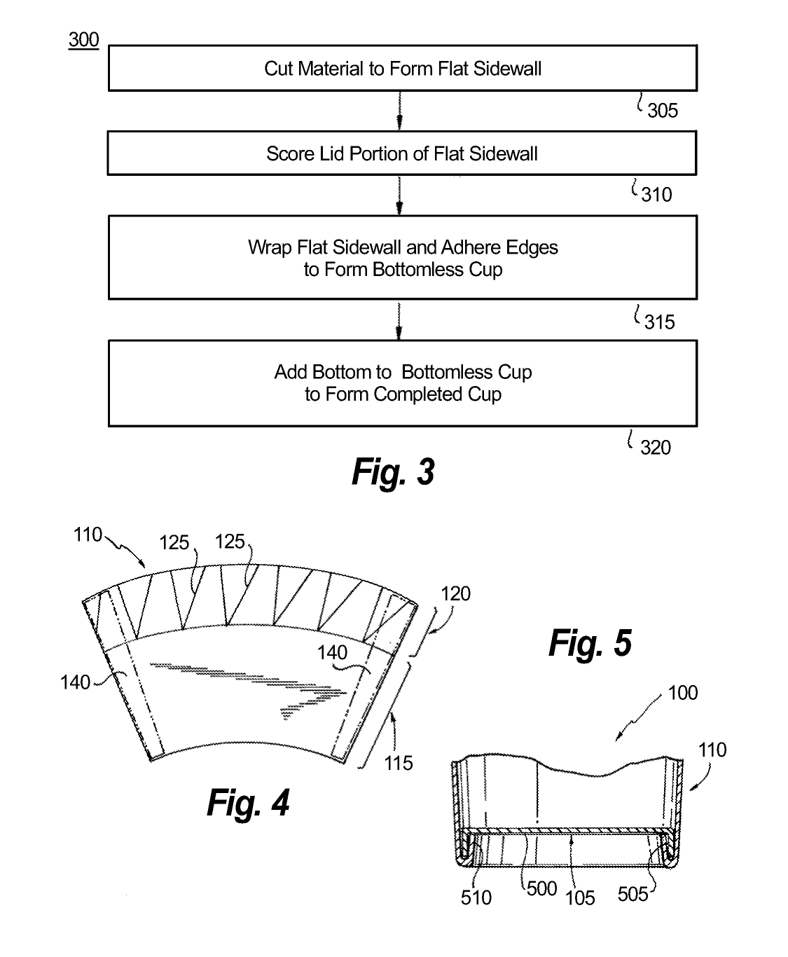

FIG. 3 shows a flow chart of a method 300 in accordance with an illustrative embodiment of the invention for forming the drink cup 100. Advantageously, while the drink cup 100, and, more generally, containers in accordance with aspects of the invention, have very novel properties, these products can still be formed using largely conventional manufacturing techniques and tooling once aspects of the present invention are understood from the teachings herein. These manufacturing techniques and tooling will already be familiar to one having ordinary skill in the relevant arts and are, furthermore, described in a number of readily available publications including, for example, G. L. Robertson, Food Packaging: Principles and Practice, Second Edition, CRC Press, 2005, and K. L. Yam, The Wiley Encyclopedia of Packaging Technology, John Wiley & Sons, 2010, which are both hereby incorporated by reference herein. Suitable industrial tooling for processing coated paper products like the drink cup 100 can be obtained from, as just two examples, Paper Machinery Corporation (Milwaukee, Wis., USA), and Rollem International (Anaheim, Calif., USA).

The exemplary method 300 starts in step 305 by receiving a flat portion of cup material (from, for example, a roll of the cup material) and cutting that cup material to form a substantially flat, two-dimensional form of the sidewall 110. As is conventional, the cup material may comprise, for example, paper coated with a water-impermeable and heat-sealable barrier material such as a plastic (e.g., polyethylene, polylactic acid) or a wax. Notwithstanding this, any equally suitable material would also fall within the scope of the invention.

Subsequently, in step 310, the upper sidewall portion 120 of the still-flat sidewall 110 is scored with the lines 125 that will ultimately allow the upper sidewall portion 120 to be folded into the lid 120 via the folding process illustrated in FIGS. 2A-2E. The scoring of the lines 125 can be accomplished by any means which reduces the cup material's stiffness along the lines 125 to aid in subsequent folding along the lines 125. Suitable means of scoring the upper sidewall portion 120 therefore include, but are not limited to, compressing the upper sidewall portion 120 along the lines 125, superficially cutting the upper sidewall portion 120 along the lines 125, creasing the upper sidewall portion 120 along the lines 125, pre-bending the upper sidewall portion 120 along the lines 125, perforating the upper sidewall portion 120 along the lines 125, or some combination thereof. Concurrently with or after the scoring of the lines 125, the weakened region 135 for the drinking straw may also optionally be defined on the sidewall 110 by, for example, a perforation process.

FIG. 4 shows a side elevational view of the sidewall 110 for the drink cup 100 after performing steps 305 and 310. The lines 125 of the upper sidewall portion 120 are clearly visible and define alternating triangular and trapezoidal shapes. Lateral margins 140 of the sidewall 110 are also marked. With these elements in place, the method 300 progresses to step 315. Step 315 comprises wrapping the sidewall 110 and heat sealing its lateral margins 140 to form the sidewall 110 into a three-dimensional hollow sleeve (i.e., a bottomless cup). In so doing, the wrapping is preferably performed such that the lateral margins 140 of the sidewall 110 marked in FIG. 4 precisely overlap one another. Alignment in this manner allows the lines 125 to properly continue around the entire periphery of the upper sidewall portion 120, even at the just-created seam.

Finally, step 320 of the method 300 involves adding the bottom 105 to the sidewall 110 formed by steps 305-315 to ultimately form the finished drink cup 100. A manner of fixating the bottom 105 to the sidewall 110 can be better understood with reference to FIG. 5, which shows a side sectional view of a lower portion of the drink cup 100 with the bottom 105 in place. The bottom 105 is received as a circular disk 500 with a downward-turned rim 505 (i.e., skirt). The bottom 105 preferably comprises the same cup material as the sidewall 110. The bottom 105 is inserted into the lower portion of the sidewall 110 and then a lower flap 510 of the sidewall 110 is wrapped around the downward-turned rim 505. The sidewall 110 (including the lower flap 510) is then heat sealed to the downward-turned rim 505 of the bottom 105 to form a watertight seal therebetween.

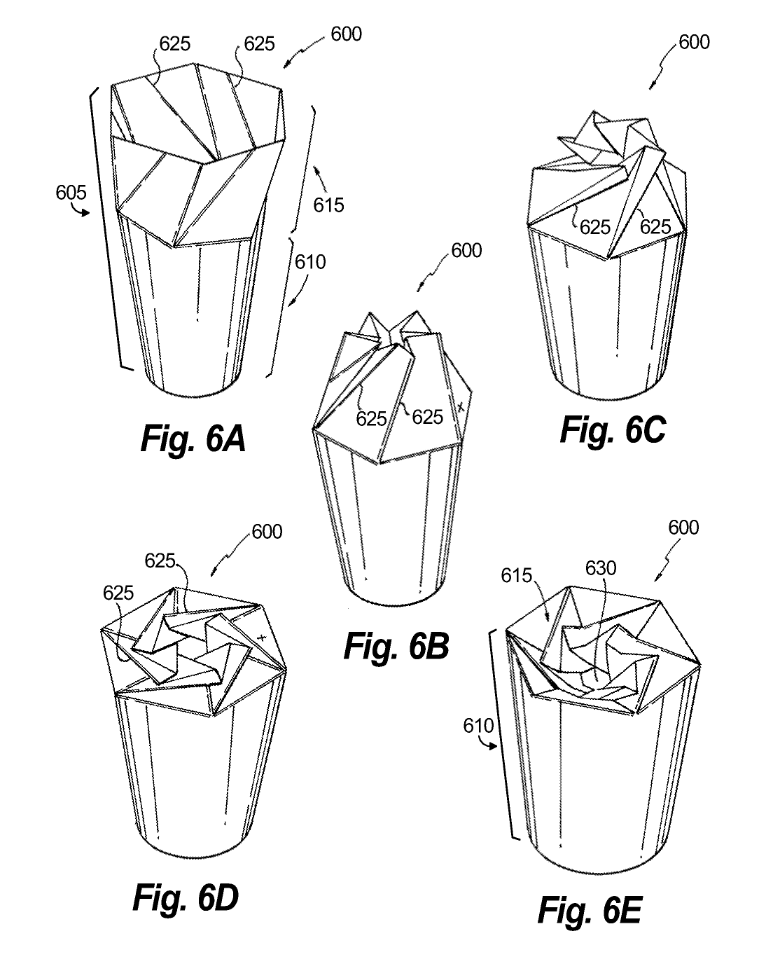

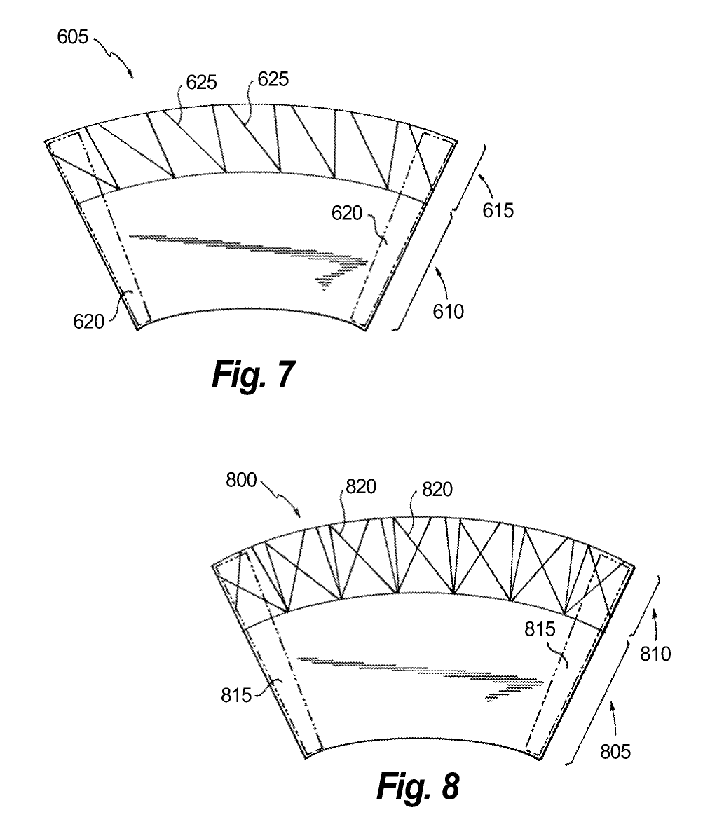

FIGS. 6A-6E and 7 go on to show aspects of a drink cup 600 in accordance with a second illustrative embodiment of the invention. FIGS. 6A-6E show side perspective views of the illustrative drink cup 600 before, during, and after folding to form a lid. Like the drink cup 100, the drink cup 600 can be conceptually separated into a bottom (not explicitly shown) and a sidewall 605 with a lower sidewall portion 610, an upper sidewall portion 615, and lateral margins 620. The drink cup 600 can be manufactured using a method like that described above with reference to FIG. 3. FIG. 7 shows a side elevational view of the flat sidewall 605 after cutting and scoring.

The upper sidewall portion 615 of the drink cup 600 is scored with a plurality of lines 625. Here again, the lines 625 define alternating triangular and trapezoidal shapes that are uniquely arranged such that folding the upper sidewall portion 615 along the lines 625 acts to convert the upper sidewall portion 615 into a lid 615 for the drink cup 600. Nevertheless, in the present embodiment, the lid 615 does not substantially fill the entire opening in the drink cup 600, but instead, defines a central hexagonal aperture 630. This central aperture 630 is best seen in FIGS. 6D and 6E. Advantageously, the central aperture 630 allows a drinking straw to be easily inserted through the lid 615.

The width of the central aperture 630 can be made to vary by minor modifications to the lines 625. Conventional drinking straws come in various common diameters starting at about three millimeters and increasing up to about 15 millimeters. The central aperture 630 therefore preferably has a width of about three millimeters or greater so that it is large enough to accommodate one or more conventional drinking straw sizes.

Finally, two additional illustrative embodiments of the invention comprise drink cups with aspects of both the drink cup 100 (i.e., a drink cup wherein the folded lid substantially fills the entire opening in the drink cup) and the drink cup 600 (i.e., a drink cup with a folded lid defining a substantial central aperture suitable for a drinking straw). For purposes of economy of description, both additional embodiments are illustrated by showing their respective flat sidewalls only. Nevertheless, it will be recognized that these sidewalls can be formed into respective drink cups by wrapping the sidewalls and adding bottoms in a manner similar to that described above with reference to steps 315 and 320, respectively, in the method 300 (FIG. 3).

FIG. 8, for example, shows a flat sidewall 800 of a drink cup design in accordance with a third illustrative embodiment of the invention. The sidewall 800 comprises a lower sidewall portion 805, an upper sidewall portion 810, and lateral margins 815, where the upper sidewall portion 810 defines scored lines 820. In this embodiment, folding the upper sidewall portion 810 along a first set of the scored lines 820 in one direction forms a lid that substantially fills the entire opening in the drink cup. In contrast, folding the same upper sidewall portion 810 along a second set of the lines 820 in the opposite direction (where the second set of lines is not mutually exclusive with the first set of lines) forms a lid with a substantial central aperture like that found in the drink cup 600. A drink cup formed from the sidewall 800 therefore has the advantage of providing a user with the option to form either kind of lid.

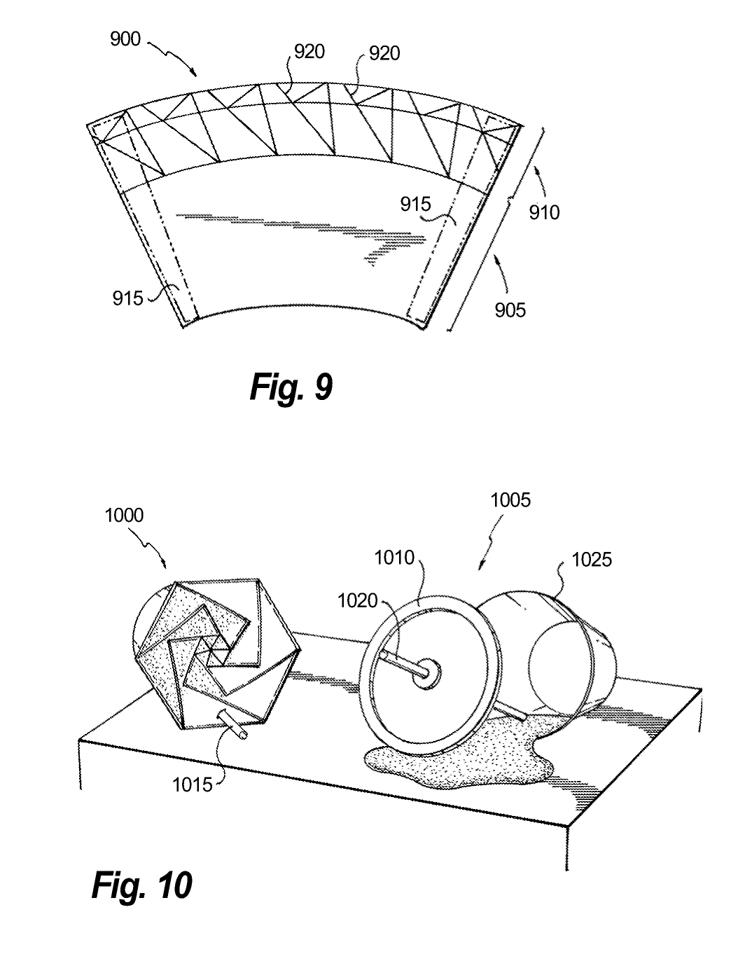

FIG. 9, in turn, shows a flat sidewall 900 of an illustrative drink cup design in accordance with a fourth illustrative embodiment of the invention. Here, the sidewall 900 comprises a lower sidewall portion 905, an upper sidewall portion 910, and lateral margins 915, with the upper sidewall portion defining scored lines 920. In this particular design, folding the upper sidewall portion 910 along a portion of the scored lines 920 allows a user to form a lid that fills substantially the entire opening in the drink cup. At the same time, additional folding along the scored lines 920 allows the user to fold back a central flap that exposes a central aperture in the lid suitable for the insertion of a drinking straw. Accordingly, here again, the user has the option as to which type of lid is desired at a given moment.

Many of the several advantages of the invention can be best appreciated by comparing a drink cup in accordance with aspects of the invention with a conventional drink cup with its separate plastic lid. FIG. 10 shows a perspective view of a drink cup 1000 similar to the drink cup 100 next to a conventional drink cup 1005 with a separate plastic lid 1010. The drink cup 1000 includes a drinking straw 1015, while the conventional drink cup 1005 includes a drinking straw 1020. Because of differences in materials, the conventional drink cup 1005 and the separate plastic lid 1010 require separate material sourcing, manufacturing, and distribution processes. In addition, the differences in materials between the conventional drink cup 1005 and the separate plastic lid 1010 require that they be separated from each other before recycling, making such recycling more difficult. Forming a protruding rim 1025 on the conventional drink cup 1005 needed to secure the separate plastic lid 1010 also requires that the conventional drink cup 1010 contain more paper. Lastly, a user of the conventional drink cup 1005 and the plastic lid 1010 must acquire two items instead of just one item.

The drink cup 1000 with its integrated lid, in contrast, addresses all these deficiencies while providing a very aesthetically pleasing, and easy to use product. At the same time, the drink cup 1000 is easy and inexpensive to produce using well understood manufacturing methods and readily available tooling. The drink cup 1000 is also less prone to spilling when mishandled, because it does not contain a lid that can separate from the remainder of the cup.

Before closing, however, it should again be emphasized that the above-described embodiments of the invention are intended to be illustrative only. Other embodiments can use different types and arrangements of elements and processing steps for implementing the described functionality. While, for example, the illustrative embodiments set forth above were directed to a drink cup, aspects of the invention could be readily applied to any container having similar features to a drink cup (e.g., bucket, tub). These numerous alternative embodiments within the scope of the appended claims will be apparent to one skilled in the art.

Moreover, all the features disclosed herein may be replaced by alternative features serving the same, equivalent, or similar purposes, unless expressly stated otherwise. Thus, unless expressly stated otherwise, each feature disclosed is one example only of a generic series of equivalent or similar features.

Any element in a claim that does not explicitly state “means for” performing a specified function or “step for” performing a specified function is not to be interpreted as a “means for” or “step for” clause as specified in 35 U.S.C. §112, ¶6. In particular, the use of “step of” in the claims herein is not intended to invoke the provisions of 35 U.S.C. §112, ¶6.

What is claimed is:

1. A container comprising:
a bottom; and
a sidewall, the sidewall coupled to the bottom so as to form a watertight seal therewith, and defining a lower sidewall portion and an upper sidewall portion;
wherein the upper sidewall portion is scored with a plurality of lines, the plurality of lines arranged such that folding the upper sidewall portion along at least a portion of the plurality of lines converts the upper sidewall portion into a lid for the container.

2. The container of claim 1, wherein the sidewall comprises paper.

3. The container of claim 2, wherein the paper is coated with at least one of a plastic and a wax.

4. The container of claim 1, wherein the sidewall, when independent of the bottom, defines a hollow sleeve.

5. The container of claim 1, wherein one of the plurality of lines runs along an interface of the lower sidewall portion and the upper sidewall portion.

6. The container of claim 1, wherein the plurality of lines define a plurality of triangles.

7. The container of claim 1, wherein the plurality of lines define a plurality of trapezoids.

8. The container of claim 1, wherein the plurality of lines comprise a superficially cut line.

9. The container of claim 1, wherein the plurality of lines comprise a creased line.

10. The container of claim 1, wherein the plurality of lines comprise a pre-bent line.

11. The container of claim 1, wherein the plurality of lines comprise a perforated line.

12. The container of claim 1, wherein the container defines an opening, and the lid fills substantially the entire opening.

13. The container of claim 1, wherein the lid defines an aperture characterized by a width greater than three millimeters.

14. The container of claim 13, wherein the aperture is substantially hexagonal.

15. The container of claim 1, wherein a rim of the lower sidewall portion substantially defines a hexagon when the upper sidewall portion is folded to form the lid.

16. The container of claim 1, wherein the lid is adapted to be manually placed into and maintain a condition wherein a center point of the lid is positioned between the bottom and a plane defined by an edge of the lower sidewall portion opposite the bottom.

17. The container of claim 1, wherein the container defines an opening, and the plurality of lines are arranged such that folding the upper sidewall portion along a first set of the plurality of lines is operative to form a lid that substantially fills the entire opening, and folding the upper sidewall portion along a second set of the plurality of lines is operative to form a lid that defines an aperture characterized by a width greater than three millimeters.

18. The container of claim 1, wherein the plurality of lines are arranged such that the lid defines an aperture characterized by a width greater than three millimeters and a flap adapted to be manually placed so as to substantially cover and substantially uncover the aperture.

19. A method of forming a container, the method comprising the steps of:
forming a sidewall, the sidewall defining a lower sidewall portion and an upper sidewall portion;
attaching the sidewall to a bottom so as to form a watertight seal therewith; and
scoring the upper sidewall portion with a plurality of lines, the plurality of lines arranged such that folding the upper sidewall portion along at least a portion of the plurality of lines forms a lid for the container.
